(19) United States
(12) Patent Application Publication
(10) Pub. No.: US 2013/0052957 A1
(43) Pub. Date: Feb. 28, 2013

(54) SHORT-RANGE DATA COMMUNICATION

(71) Applicants: Daniel Noel Badiere, Ottawa (CA); Arnold Sheynman, Northbrook, IL (US); Tongyan Zhai, Buffalo Grove, IL (US); Steve Hranilovic, Oakville (CA)

(72) Inventors: Daniel Noel Badiere, Ottawa (CA); Arnold Sheynman, Northbrook, IL (US); Tongyan Zhai, Buffalo Grove, IL (US); Steve Hranilovic, Oakville (CA)

(21) Appl. No.: 13/594,188

(22) Filed: Aug. 24, 2012

Related U.S. Application Data
(60) Provisional application No. 61/527,937, filed on Aug. 26, 2011.

(51) Int. Cl. H04B 7/24

(52) U.S. Cl. 455/41.2

(57) ABSTRACT

In some implementations, a method for wireless data communication includes detecting a short-range proximity of a device. In response to at least the detected short-range proximity, a connection to a mechanical assembly is emulated. A communication link including a wireless link is established with the device by transmitting a request according to a wired standard. Signals formatted in accordance with the wired standard are communicated with the device through the wireless link.

### CROSS-REFERENCE TO RELATED APPLICATIONS

This application claims the benefit under 35 U.S.C. §119(e) of U.S. Provisional Application No. 61/527,937 filed on Aug. 26, 2011, hereby incorporated by reference in its entirety.

### TECHNICAL FIELD

This disclosure relates to communication networks and, more particularly, to communicating short-range wireless data.

### BACKGROUND

Universal Serial Bus (USB) 3.0 is a wired communication standard that transmits signals over conductive cables. The USB3.0 standard supports two main modes of operation: (i) SuperSpeed mode (5 Gb/s); and (ii) USB2.0 backward compatible mode. Wired links can be restrictive to users (as devices are mechanically tethered to each other) and to designers (who must incorporate mechanical connectors in their designs). Wireless links can offer more convenience by eliminating the aforementioned issues, however they often require special protocol suited to the challenges posed by air or free space interfaces.

### DESCRIPTION OF DRAWINGS

FIG. 1 is an example system for emulating a wired connection between two devices using a wireless interface;

FIG. 2 is an example connection using a wireless link;

FIG. 3 is an example system for detecting presence of a receiver over a wired link;

FIG. 4 another example system for detecting proximity of a device;

FIG. 5A illustrates is a front and side view of a system for using a wireless link to communicate between a tablet and a dock;

FIG. 5B illustrates a cross-sectional view of the system using a wireless link; and

FIG. 6 is a flowchart for illustrating an example method for communicating using a wireless link according to a wired standard.

Like reference symbols in the various drawings indicate like elements.

### DETAILED DESCRIPTION

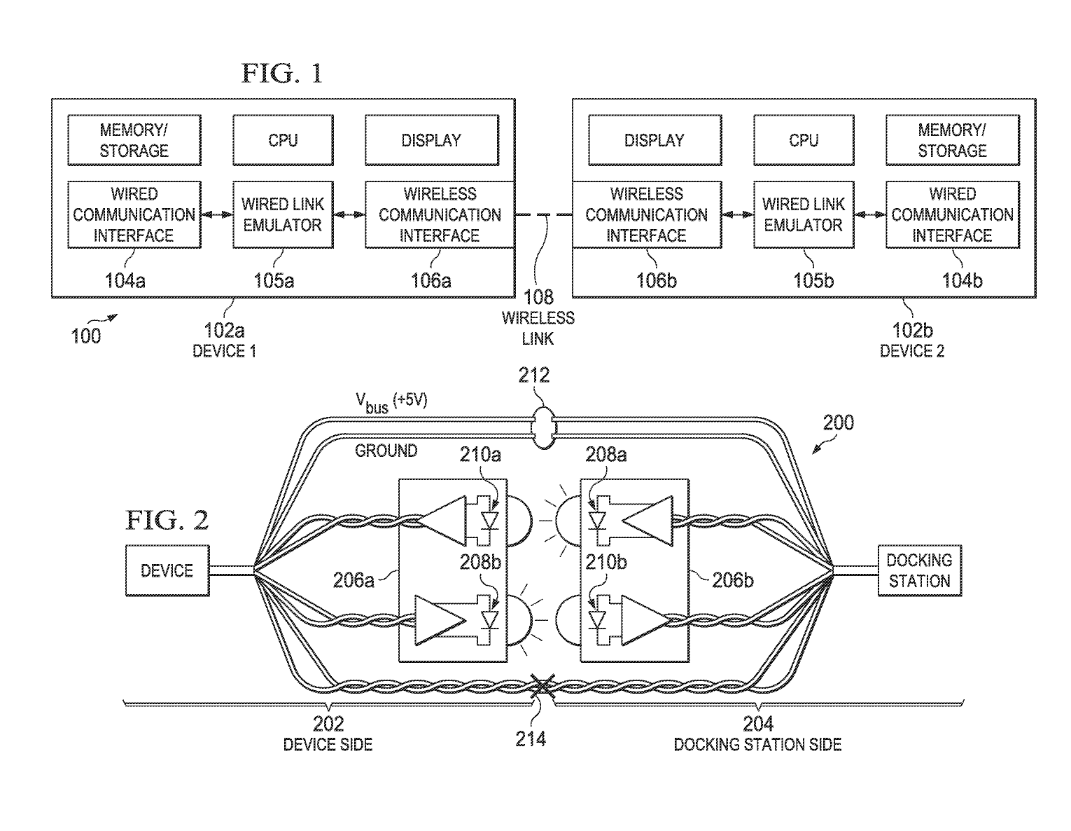

FIG. 1 illustrates an example system 100 for emulating a wired connection using a short-range wireless link. For example, the system 100 may communicate, through a wireless link, short-range wireless data between devices using a wired standard. Wireless, as used herein, means absence of a mechanical assembly that would join the device to a waveguide, a fiber optic, or an electrically conducting cable intended for data transfer. For example, the system 100 may transmit, through a short-range link between two devices, data in accordance with a wired standard using, for example, lasers and photo diodes. In some implementations, a short range may include a range from about an inch or less. In general, wired standards may include Universal Serial Bus (USB) (e.g., USB 3.0), Peripheral Component Interconnect Express (PCIe), High-Definition Multimedia Interface (HDMI), DisplayPort, Digital Visual Interface (DVI), or other standards that define hardware (e.g., cables, connectors) and protocols for communicating signals through a wired connection (e.g., serial connection, optical fiber connection). As described, the system 100 may wirelessly communicate through a short-range link to emulate, for example, a USB 3.0 SuperSpeed communication link as discussed in Section 3. In addition, the system 100 may communicate, through a wireless link, signals based on a wired standard independent of or without any changes or additions to the wired standard (e.g., USB 3.0). In other words, the system 100 may communicate, through a wireless link, USB 3.0 messages without modifying the USB 3.0 protocol as discussed in Section 8. While the following description focuses on USB 3.0 SuperSpeed, the system 100 can be applied to any wired standard using, for example, unidirectional serial data lines without departing from the scope of the disclosure.

In some implementations, the system 100 may execute one or more of the following: determine a proximity of two devices is within a predefined range; emulate an electrical connection between the devices; initiate a detection sequence in response to at least the emulated electrical connection; establish a communication link between two devices based on the detection sequence; receive an electrical signal through a wired connection formatted in accordance with a wired standard; convert the electrical signal to a wireless signal (e.g., optical signal, NFC signal, RF signal, etc.) formatted in accordance with the wired standard; transmit the wireless signal from one device to a second device through a short-range wireless connection; convert the wireless signal to the electrical signal formatted in accordance with the wired standard; or others. By emulating a wired connection, the system 100 may communicate signals formatted in accordance with wired standards independent or without users being restricted to mechanical tethers, designers having incorporated mechanical connectors in designs, or a combination of the forgoing.

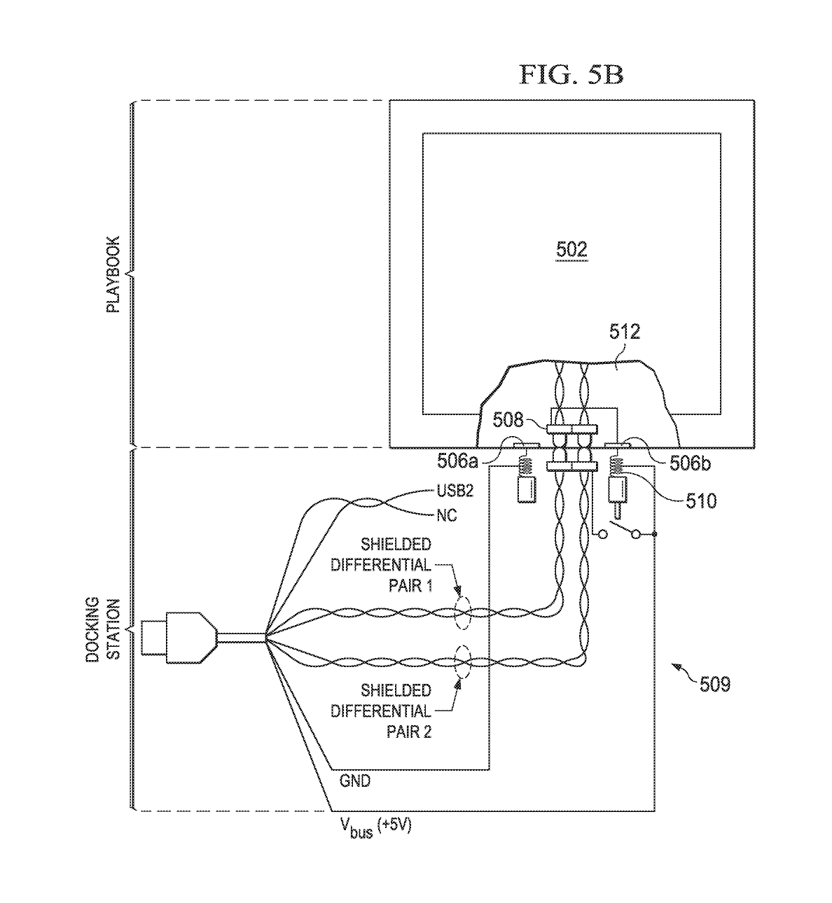

As for a high-level description, the system 100 includes devices 102a and 102b that wirelessly communicate through a short-range, wireless link 108 using signals formatted in accordance with a wired standard. As illustrated, the device 102 includes a wired communication interface 104a, b, a wired link emulator 105a, b, and a wireless communication interface 106a, b. The wired communication interface 104a, b identifies an electrical connection emulated by the wireless communication interface 106a, b, establishes a communication link with the other wired communication interface 104a, b, and communicates, in accordance with a wired standard, electrical signals through a wired connection with the wireless communication interface 106a, b. The wired link emulator 105a, b is configured to emulate a connection (e.g., electrical connection) in response to at least proximity of the other device 102a, b. In some implementations, the device 102a, b may include a proximity module configured to detect proximity of the other device 102a, b. For example, the device 102a may include the proximity module configured to detect proximity of the other device 102b. The proximity module may be included in the wireless communication interface 106a, b, the wired link emulator 105a, b, or a standalone module as illustrated in FIG. 5. The wireless communications interface 106a, b communicates, through the wireless link 108, wireless signals with the other device 102a, b in accordance with the wired protocol of the wired standard. As for a high-level description of operation, the proximity module of the device 102a may determine proximity of the other device 102b in response to, for example, activation of a switch. In response to the detected proximity, the wired link emulator 105a may emulate an electrical connection with the device 102b. Based on detecting the emulated electrical connection, the wired communication interface 104b may establish a communication link with the wired communication interface 104a in accordance with the wired standard. The wired communication interface 104a may also establish a communication link with the wired communication interface 104b in accordance with the wired standard. While transparent to the wired communication interface 104a and 104b, the wireless communication interfaces 106a and 106b convert between electrical signals and wireless signals (e.g., optical signal) formatted in accordance with the wired standard.

Turning to a more detailed description of the elements, the device 102a, b may receive and transmit communications within the system 100. As used in this disclosure, the device 102a, b is intended to encompass tablet computers, cradles, docks, cellular phones, data phones, pagers, portable computers, SIP phones, smart phones, personal data assistants (PDAs), digital cameras, MP3 players, camcorders, one or more processors within these or other devices, or any other suitable processing devices capable of communicating information. In some implementations, the device 102a, b may be based on a cellular radio technology. For example, the device 102a, b may be a tablet computer operable to wirelessly connect with an external or unsecured network. In another example, the device 102a, b may comprise a device 102a, b that includes an input device, such as a keypad, touch screen, mouse, or other device that can accept information, and an output device that conveys information associated with the system 100. In the illustrated implementation, the device 102a, b includes a wired communication interface 104a, b, wired link emulator 105a, b, wireless communication interface 106a, b as well as other components such as memory/storage, a Central Processing Unit (CPU), a display, and others. The wired communication interface 104a, b may include any hardware, software, firmware, or a combination thereof for communicating electrical signals in accordance with a wired standard. For example, the wired communication interface 104a, b may be a USB interface configured to communicate electrical signals in accordance with the USB 3.0 protocol as described in Section 8. In some implementations, the wired communication interface 104a, b may detect an electrical connection and establish a communication link in response to at least the connection. For example, the wired communication interface 104a, b may detect a load indicating a connected device and execute a detection sequence in response to at least the load.

The wired link emulator 105a, b may include any hardware, software, firmware, or a combination thereof for emulating a physical connection to another device 102a, b. For example, the wired link emulator 105a, b may emulate an electrical connection using a mechanical assembly configured to connect to an electrically conducting cable. In some implementations, the wired link emulator 105a, b may include a circuit that emulates a load when an electrical connector is inserted into a mechanical assembly. For example, the wired link emulator 105a, b may include a resister circuit or resister-capacitor (RC) circuit.

The wireless communication interface 106a, b may include any hardware, software, firmware, or a combination thereof for communicating using the wireless link 108 transparent to the wired communication interface 104a, b. For example, the wireless communication interface 106a, b may convert between an electrical signal formatted in accordance with a wired standard and a wireless signal formatted in accordance with a wired standard and transmit the wireless signal through the wireless link 108. In some implementations, the wireless communication interface 106a, b may transmit, through the wireless link 108, the wireless signals formatted in accordance with the wired standard independent of or without updating or otherwise modifying an interface protocol for the wired standard. In some implementations, the wireless communication interface 106a, b may include one or more lasers (e.g., solid-state laser) for converting the electrical signal directly to an optical signal formatted in accordance with the wired standard. In addition, the wireless communication interface 106a, b may include a photo detector to convert the optical signal to an electrical signal. In these instances, the device 102a may include a laser aligned with a photo detector in the device 102b, and the device 102b may include a laser aligned with a photo detector in the device 102a. In some implementations, these wireless interface components can operate at the same data rates of wired interfaces. For example, the optical components and associated electronics can operate at a 5 Gb/s data rate of USB 3.0 SuperSpeed. In some implementations, the wireless communication interface 106a, b can determine that another device 102a, b is within a predefined proximity and, in response to at least this determination, emulate an electrical connection. For example, the wireless communication interface 106a, b may include a switching module that switches on in response to the other device 102a, b being within predefined range. In these examples, the switching module may complete a circuit in the wired link emulator 105a, b that emulates an electrical connection to the wired communication interface 104.

While the devices 102a and 102b are illustrated as including a display, the devices 102a and 102b may not include a display or include an interactive display. For example, the display may be a Graphical User Interface (GUI) operable to allow the user of the device 102a, b to interface with at least a portion of the system 100 for any suitable purpose, such as short-range wireless communication formatted in accordance with a wired standard. Generally, the GUI provides the particular user with an efficient and user-friendly presentation of data provided by or communicated within the system 100 and/or also an efficient and user-friendly process for the interacting with users. The GUI may comprise a plurality of customizable frames or views having interactive fields, pull-down lists, and/or buttons operated by the user. The term graphical user interface may be used in the singular or in the plural to describe one or more graphical user interfaces and each of the displays of a particular graphical user interface. The GUI can include any graphical user interface, such as a generic web browser or touch screen that processes information in the system 100 and presents the results to the user.

FIG. 2 illustrates an example wireless USB 3.0 SuperSpeed link 200. The wireless link includes unidirectional data lines that are connected to optical components to convert the electrical signals into optical signals. By including the optical components, the USB 3.0 SuperSpeed link may be maintained by converting the electrical signals into optical signals which can be sent over-the-air such as over a short-range wireless link. While the USB 2.0 compatibility lines are not connected as illustrated at portion 214, the circuit 200 may include these lines without departing from the scope of this disclosure. By using a duplexing circuit (to handle the bidirectionality of the USB 2.0 lines) on each side of the broken USB 2.0 lines, an optical interface may be included at portion 214 as well.

Turning to the illustrated implementation, the connection 200 includes a device side 202 and a docking side 204 that include an optical module 206a and 206b, respectively. The optical module 206a, b converts between electrical and optical signals where both are formatted in accordance with a wired standard (e.g., USB 3.0 SuperSpeed protocol). The optical module 206a, b includes a laser 208a, b and a photo detector 210a, b. The laser 208a of the docking side 204 is substantially aligned with the photo detector 210a of the device side 202, and the laser 208b of the device side 202 is substantially aligned with the photo detector 210b of the docking side 204. In some implementations, the optical modules 206a and 206b may be powered by the V_{bus} +5V line. In some implementations, the Vbus +5V line or the ground may be maintained along the connection 200 using a tab, pin or other direct contact.

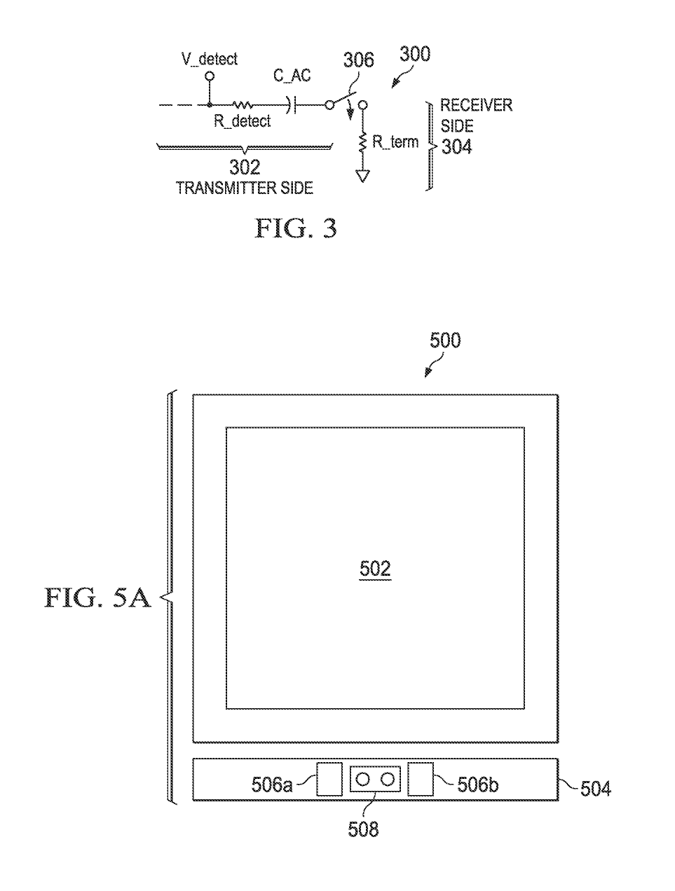

FIG. 3 illustrates an example interface 300 that detects connection of two devices. In general, USB 3.0 SuperSpeed is a very high speed interface (5 Gb/s) that includes set procedures for establishing a link. To invoke this link establishment protocol, the USB 3.0 hosts and devices may detect that an appropriate device has been connected. This process is called the RX Detect Sequence as described in Section 6 of the USB 3.0 specification. RX Detection includes the transmitter on each device observing an exponential voltage function created by the charging of a capacitor through resistance, where the RC circuit is completed by the termination resistance of the USB 3.0 receiver at the far end of the unidirectional serial line.

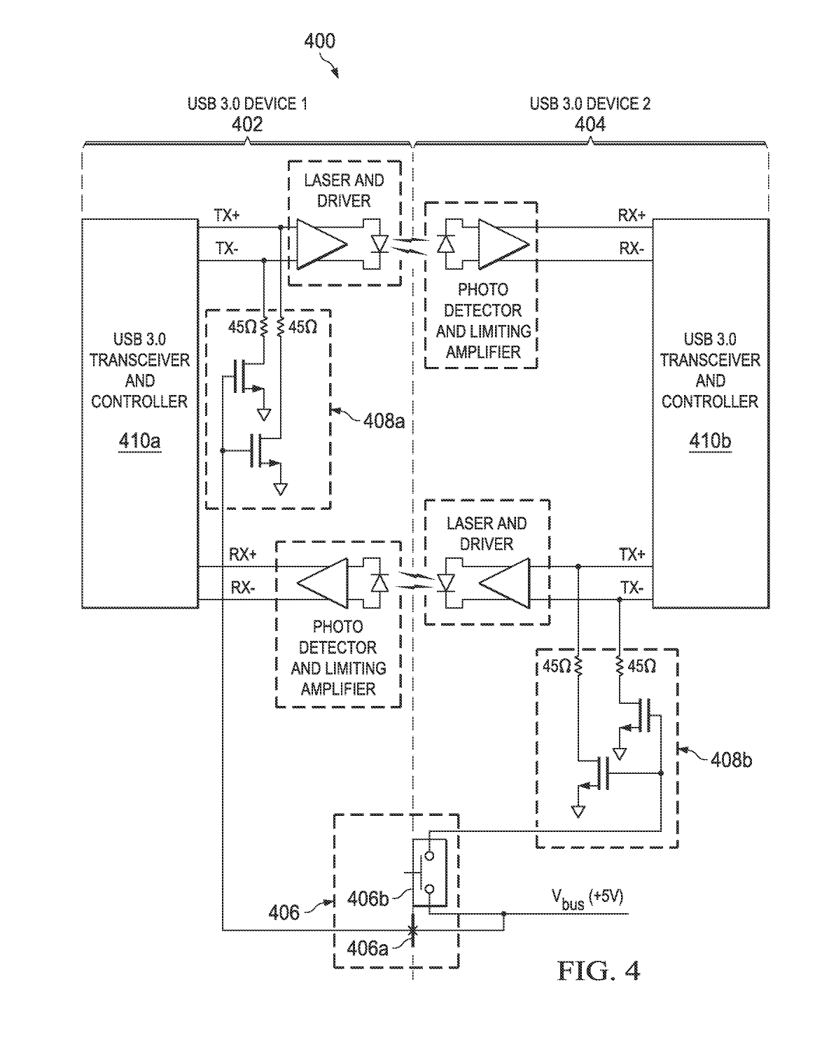

As illustrated, the interface 300 includes a transmitter side 302, a receiver side 304, and a mechanical connection 306. The mechanical connection 306 can represent the absence of the USB 3.0 cable connecting the transmitter and receiver (open) or the presence of the cable connecting the transmitter and receiver (closed). When the transmitter side 302 and the receive side 304 are connected by a mechanical connection 306 that is USB 3.0 compliant cable, the RC circuit is completed (switch closed) such that the RX Detect Sequence is executed. In comparison, since the wired connection between the transmitter and receiver in a wireless link is no longer present, RX Detection may be completed using other processes as described with respect to FIG. 4.

FIG. 4 illustrates an example system 400 for emulating an electrical connection in response to at least proximity between two devices. As illustrated, the system 400 includes USB 3.0 device 402 proximate USB 3.0 device 404. The USB 3.0 device 404 includes a proximity module 406 and an emulation circuit 408. The proximity module 406 includes a contact pad 406a and a proximity switch 406b. Once the contact pad 406a is contacted or the proximity switch 406b is closed, the V_{bus} is applied to the emulation circuit 408 such that the device 404 perceives an electrical connection with the device 402. By emulating an electrical connection, the system 100 may allow a wired connection to become wireless, which may not include modification of the USB 3.0 protocol stack. The USB transceiver and controllers 410 do not have “knowledge” of the optical portion of the link, so the optical portion of the link is transparent to the USB transceiver and controllers 410.

In other words, the system 400 illustrates a circuit that would allow the RX Detection routine to be triggered by the placement of the two USB 3.0 devices within a proximity defined for optical communication. The proximity switch 406b, which could be for example a mechanical switch in a docking station or a light sensor, would close when the devices are proximate. This connection may provide +5V to the RX Detect switches in the emulation circuit 408, actuating them to a closed state. In addition, this implementation may provide a path to ground for the termination loads connected to the data lines, which may complete the RC charging circuit that would be detected by the USB 3.0 device 2 404 for the RX Detect sequence. The connection of the V_{bus} signal from the USB 3.0 device 2 404 in the USB 3.0 device 1 402 via the contact pad 406a actuates switches providing a path to ground for the termination loads connected to the data lines which complete the RC charging circuit that would be detected by the USB 3.0 device 1 402 for the RX Detect sequence.

FIGS. 5A and 5B illustrate an example system 500 for transmitting signals formatted in accordance with a wired standard through a wireless link. As illustrated, the system 500 includes a tablet computer 502 and a side view 504 of the computer 502. Referring to FIG. 5A, the side view 504 includes electrical contacts 506a and 506b and an optical module 508. The electrical contacts 506a and 508b may pass DC signals to the tablet computer 502, and the optical module 508 may transmit, through a wireless link, data formatted in accordance with a wired standard. For example, the electrical contacts 506a and 506b may be DC contact pads, and the optical module 508 may transmit data in accordance with the USB 3.0 SuperSpeed wired standard. Referring to FIG. 5B, the tablet 502 is docked in the docking station 509. The docking station 509 contacts the electrical contacts 506a and 506b through spring load pins 510. The internal view 512 illustrates that once docked the optical module of the docking station 509 aligns with optical components 506a and 506b of the tablet 502. The illustrated implementation, the tablet 502 and the docking station 509 communicate using Shielded Differential Pair 1 (SDP1) and Shielded Differential Pair 2 (SDP2). As previously mentioned, the metal contact pads of the docking station 509 may connect the device 502 using the +5V V_{bus} signal from the docking station 509. In some implementations, this V_{bus} connection can trigger the RX Detection routine of USB 3.0 as discussed above.

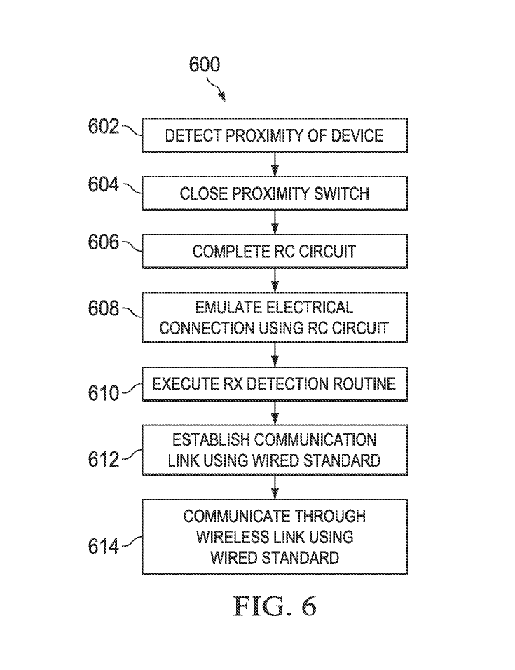

FIG. 6 is a flow chart illustrating an example method 600 for communicating in accordance with a wired standard using a wireless link. The illustrated method 600 is described with respect to system 100 of FIG. 1, but this method could be used by any other suitable system. Moreover, system 100 may use any other suitable techniques for performing these tasks. Thus, many of the steps in this flowchart may take place simultaneously and/or in a different order than the order shown. System 100 may also use methods with additional steps, fewer steps, and/or different steps, so long as the methods remain appropriate.

Method 600 begins at step 602 where proximity of a device is detected. In FIG. 1, the device 102a may detect the proximity of the device 102b using, for example, an electrical switch. At step 604, a proximity switch is closed. For example, the proximity switch 406b in FIG. 4 may be closed to complete an RC circuit (step 606). As for the example in FIG. 4, when the switch 406b is closed, the V_{bus} may apply +5V to the emulation circuit 408. An electrical connection is emulated using the RC circuit at step 608. Again in the example, the emulation circuit 408 completes an RC circuit that emulates an electrical connection when the proximity switch 406b is closed. In response to at least detecting an electrical connection, a receiver detection and validation routine is executed at step 610. As for the example, the device 404 executes a routine to detect and validate the receiver of the device 402 in response to detecting an electrical connection emulated using the RC circuit 408. Similarly, the device 402 may detect device 404 using an analogous processes. At step 612, the two devices establish a communication link in accordance with the wired standard. In regards to FIG. 1, the wired communication interfaces 104a and 104b may establish a communication link through the wireless link 108 such that the wireless link 108 is transparent to the interfaces 104. Next, at step 614, the two devices communicate through the wireless link using the wired standard. As for the example in FIG. 1, the wireless communication interfaces 106 may communicate signals formatted in accordance with the wired standard and through the wireless link 108.

A number of embodiments of the disclosure have been described. Nevertheless, it will be understood that various modifications may be made without departing from the spirit and scope of the disclosure. Accordingly, other embodiments are within the scope of the following claims.

What is claimed is:

1. A method for wireless data communication, comprising:
detecting a short-range proximity of a device;
in response to the detected short-range proximity, emulating a connection to a mechanical assembly according to a wired standard;
establishing, through a wireless link, a communication link with the device using the wired standard; and
communicating, with the device through the wireless link, signals formatted in accordance with the wired standard.

2. The method of claim 1, wherein detecting a short-range proximity further comprises closing a switch in response to contact with the device.

3. The method of claim 1, wherein emulating a connection to a mechanical assembly comprises powering a Resistor-Capacitor (RC) circuit configured to emulate an electrical connection.

4. The method of claim 1, wherein establishing a communication link comprises executing a receiver (RX) Detect Sequence.

5. The method of claim 1, the communication link comprises a USB 3.0 (SuperSpeed mode) link.

6. The method of claim 1, wherein the wireless link comprises an optical link.

7. The method of claim 6, wherein optical link comprises an infrared optical link.

8. The method of claim 6, further comprises converting between electrical and optical signals.

9. The method of claim 1, wherein the short-range proximity comprises about three centimeters or less.

10. The method of claim 1, wherein the device comprises a tablet computer or a docking station for a tablet computer.

11. A first device, comprising:
a proximity module configured to detect a short-range proximity of a second device;
a wired link emulator configured to emulate a connection to a mechanical assembly in response to at least the detected short-range proximity;
one or more controllers configured to establish, through a wireless link, a communication link with the second device using the wired standard; and
a wireless communication module configured to communicate, with the second device through the wireless link, signals formatted in accordance with the wired standard.

12. The device of claim 11, wherein the proximity module further configured to close a switch in response to physical contact with the second device.

13. The device of claim 11, wherein the wired link emulator includes a circuit configured to emulate an electrical connection.

14. The device of claim 11, wherein the one or more controllers configured to establish a communication link comprises the one or more controllers configured to execute a receiver (RX) Detect Sequence.

15. The device of claim 11, wherein the communication link comprises a USB 3.0 (SuperSpeed mode) link.

16. The device of claim 11, wherein the wireless link comprises an optical link.

17. The device of claim 16, wherein optical link comprises an infrared optical link.

18. The device of claim 16, further comprises a converter configured to convert between electrical and optical signals.

19. The device of claim 11, wherein the short-range proximity comprises about three centimeters or less.

20. The device of claim 11, wherein the second device comprises a tablet computer or a docking station for a tablet computer.

21. A first device, comprising:
a switch configured to close in response to physical contact with a second device;
in response to closing the switch, a Resistor-Capacitor (RC) circuit configured to emulate an electrical connection;
one or more controllers configured to establish a USB 3.0 (SuperSpeed mode) link by executing a receiver (RX) Detect Sequence, wherein the USB 3.0 (SuperSpeed mode) link includes a wireless link; and
a wireless communication module configured to communicate, with the second device through the wireless link, signals formatted in accordance with the wired standard.

22. The device of claim 21, wherein the wireless link comprises an optical link.

23. The device of claim 21, wherein the first device comprises a tablet computer and the second device comprises a docking station for a tablet computer.
